(19) United States
(12) Patent Application Publication
(10) Pub. No.: US 2002/0103852 A1
(43) Pub. Date: Aug. 1, 2002

(54) System for optimizing investment performance

(76) Inventor: Wayne L. Pushka, Toronto (CA)

Correspondence Address: Mark D. Simpson, Esq., SYNNESTVEDT & LECHNER LLP, Suite 2600 Aramark Tower, 1101 Market Street, Philadelphia, PA, 19107, US

(21) Appl. No.: 09/770,930

(22) Filed: Jan. 26, 2001

(51) Int. Cl. G06F 17/60; G06F 15/16

(52) U.S. Cl. 709/203; 705/35

(57) ABSTRACT

The present invention provides a method and system for optimizing investment performance of an economic entity. The method includes the steps of transferring market risk but not credit risk from a first account to a second account through a counterparty and recognizing either gains and losses in the second account at a future date from the original investment date. The market risk is preferably transferred between the first and second accounts by way of derivative transactions. The system includes a means for processing data relating to a transfer of market risk but not credit risk from the first account to the second account through a counterparty and a means for calculating either gains or losses in the second account at a future date from the investment date. The invention also provides a computer readable storage medium containing computer executable code for instructing a computer to carry out the invention.

### FIELD OF THE INVENTION

The present invention relates to investment systems and methods for transferring market risk of an economic entity between regulatory environments.

### BACKGROUND OF THE INVENTION

Economic entities include corporations, organizations, individuals, households, trusts, charities and families. These entities must manage their investments in more than one regulatory environment. Regulatory environments differ in terms of investment transfer penalties or restrictions. These penalties or restrictions impede an economic entity's ability to effectively manage its portfolio of investments. A dilemma faced by an economic entity is how to structure its portfolio in an optimal manner in view of transfer penalties and restrictions. The problem is compounded by the fact that uncertainties surround both investment performance and future needs.

Regulatory environments can arise geographically such as in different nations, states, provinces, territories and municipalities. Different regulatory environments also exist in the same geographical regions. Statutes such as the tax code, incorporation acts and trust acts define regulatory environments. In addition, regulatory environments are provided through rights such as basic property rights. For example, a corporation may have a defined benefit plan for its employees. This plan will have assets and liabilities. The corporation will also directly hold assets and liabilities. If the corporation is a multinational, these directly held assets and liabilities may be held by numerous subsidiary companies in other nations and jurisdictions. The corporation, its defined benefit pension plan, and subsidiary companies, are all part of the same economic entity, although they are in separate regulatory environments.

An economic entity such as a family can be faced with just as complex a structure. In the case of a husband, wife and two children, the assets can be divided into a number of regulatory subsets including the exclusive assets of the husband, the restricted assets of the husband (such as an American “401(k)” plan, or an “IRA”), the exclusive assets of the wife, the restricted assets of the wife, the exclusive assets of each child, the restricted assets of each child such as trusts, the joint assets of the husband and wife and the family home.

Many regulatory environments will have some form of transfer penalties or restrictions. These restrictions can range from fair market rules, such as when one transfers an asset to a spouse, to complete bans, as in the case of some pension plans that are prohibited from transferring assets back to their corporate sponsor. Penalties can be in the form of excise taxes for withdrawals, punitive taxation rates and in some extreme cases, criminal charges.

These restrictions create a variety of problems for the economic entities involved. These problems typically result in sub-optimal investment strategies, which eventually lowers the entity's net return. The restrictions, in effect, are costs incurred by the entity. These costs can manifest themselves in a variety of ways, through such mechanisms as punitive taxation, distorted investment and saving choices, and the time value of money. Punitive taxation causes distortions for individuals who have retirement savings vehicles such as American 401(k) plans and IRA plans. For a household with a moderate income, the majority, if not all, of their equity and fixed income investments are held in these restricted accounts. While these accounts have the benefit of income accruing tax free, withdrawals from most of these accounts are taxed as ordinary income. Therefore, upon withdrawal, all capital gains and dividends are taxed in the same high bracket as interest and income. Also, in many cases, further penalties are imposed if assets are withdrawn prior to a certain age. This punitive taxation is a direct cost to the investing economic entity. It also affects the investor's willingness to use the account as a savings vehicle since they must pay early withdrawal penalties if an unforeseen requirement for funds occurs prior to retirement.

The withdrawal restrictions and penalties for defined benefit pension plans cause the economic value of an additional dollar in a plan to decline as the plan assets exceed the economic value of the obligation. For a sponsor corporation, the cost of a plan is the present value of future contributions less the value of withdrawing the revertible surplus out of the plan. Since the surplus cannot be claimed without a substantial penalty, the value of the surplus withdrawal will usually be considerably less than the face value of the surplus. Most corporations benefit from a surplus by reducing contributions. But the minimum contribution for a given year is zero. A negative contribution is a withdrawal. Therefore, the value of a surplus is based on how it reduces the company's future contributions. Each additional dollar added to the surplus saves the company less in terms of the present value of future contributions.

These various restrictions and penalties are a material cost to the investor. Previous approaches have attempted to address these problems in a number of ways. The most common previous approach involves the process of forecasting the entity's financial requirements, forecasting investment performance and then managing risks based on these forecasts. Another previous approach is political lobbying in order to change the rules. These approaches each have significant drawbacks.

The actuarial industry is based on forecasting the financial requirements of such institutions as pension funds, life insurers and property and casualty insurers. Financial, estate, retirement, family and career planning all contain methodologies to assist smaller entities such as individuals and families in forecasting their future requirements. These methods can range from simple rules to elaborate statistical models.

Large parts of the fund management, securities and banking industries, as well as the economics profession are focused on improving the forecasting of investment performance. There are enormous advantages to be had if one has superior forecasting skills. Unfortunately, there is very little evidence that any one person or organization is capable of maintaining a superior forecasting advantage for long.

The portfolio management and financial planning industries attempt to assist investors by taking forecasts and developing investment strategies to mitigate these uncertainties and risks. These methods are predicated on the principles of modern portfolio theory which range from simple techniques such as diversification and asset allocation to more complex methods such as portfolio insurance, dynamic asset allocation, value and growth investing, hedge funds, tactical asset allocation and other complex derivative based techniques. These methods can be used to enhance returns within a given portfolio, or distribute risk between different portfolios.

Some of these methods are effective for certain investors in multiple regulatory environments. For example, wealthy investors with a restricted account such as a 401(k) plan, would structure their portfolio such that lower risk assets like fixed income investments would be held within the restricted account while higher risk assets like equities would be in their regular account. This results in maximizing the benefits of the 401(k) plan's tax deferral attributes while minimizing the negative effects of withdrawals being taxed as ordinary income. Other mechanisms for distributing risk include assets that are divided into different classes of shares such as equity dividend shares and capital yield shares. While this method has advantages, it has two distinct disadvantages. The first is that it splits the portfolio into two different classes of shares, therefore the portfolio has two types of equity. Secondly, it divides the portfolio based upon the type of distribution of the underlying shares (dividends and capital gains) as opposed to the risk associated with the portfolio's behavior. It has limited use for the investor with multiple regulatory environments since it can be replicated using the aforementioned method.

The prior art of forecasting an entity's financial requirements, forecasting investment performance and then structuring a portfolio based on these forecasts is highly complex. Since forecasting is inherently unreliable, the prior art has severe limitations no matter how sophisticated the technique being used.

Another prior art involves political lobbying. It is used when a problem becomes apparent rather than proactively. This approach is only available to politically influential individuals or organizations.

Previous methods are cumbersome when dealing with investing within multiple regulatory environments. Problems arise not because there is an imbalance of assets between the environments, but rather because the investor has not accurately predicted investment performance. In effect, it is the unforeseen growth (or lack thereof) of the investment that ultimately causes the imbalance.

There is therefore a need for an investment system that optimizes an economic entity's investment performance. There is a need for a system that transfers an economic entity's investment risk between different regulatory environments while still maintaining the advantages of holding the investments in an initial environment. There is a further need for a system that creates a more flexible investment structure that can be adapted to a multiple regulatory environment.

### SUMMARY OF THE INVENTION

The invention provides a method for optimizing the investment performance of an economic entity including the step of transferring market risk but not credit risk from a first account to a second account. The invention also provides a system for optimizing the investment performance of an economic entity including means for transferring market risk but not credit risk from a first account to a second account. The invention includes a memory and data processor for implementing the system.

According to one aspect of the present invention there is provided a method of optimizing investment performance of an economic entity comprising the following steps:

providing on an investment date, a first account in a first regulatory environment, the first account owning an investment portfolio;

providing a second account in a second regulatory environment;

transferring market risk but not credit risk from the first account to the second account through a counterparty; and

recognizing one of gains and losses in said second account at a future date from the investment date.

According to another aspect of the present invention there is provided a system for optimizing investment performance of an economic entity comprising:

a first account in a first regulatory environment, said first account owning an investment portfolio on an investment date;

a second account in a second regulatory environment;

means for processing data relating to a transfer of market risk but not credit risk from the first account to the second account through a counterparty; and

means for calculating one of gains and losses in said second account at a future date from the investment date.

According to another aspect of the present invention there is provided a system for transferring market risk but not credit risk of an economic entity from a first account owning an investment portfolio in a first regulatory environment to a second account in a second regulatory environment, the system comprising:

a memory for storing data relating to assets in said first and second accounts; and

a data processor for processing the data and calculating the value of said assets.

According to yet another aspect of the present invention there is provided a data processing system for managing the investment performance of an economic entity having a first account in a first regulatory environment and a second account in a second regulatory environment, said first account having an investment portfolio on an investment date, the system comprising:

a data processor for processing data relating to a transfer of market risk but not credit risk from the first account to the second account through a counterparty; and

a computer for storing data relating to assets in the first and second accounts and calculating one of gains and losses in the value of assets in said second account at a future date from the investment date.

According to another aspect of the present invention there is provided computer readable storage medium containing computer executable code for instructing a computer to operate as follows:

storing data relating to a first account in a first regulatory environment, the first account owning an investment portfolio on an investment date;

storing data relating to a second account in a second regulatory environment;

processing data relating to a first derivative transaction between the first account and a first counterparty whereby market risk is transferred to the first counterparty; and

processing data relating to a second derivative transaction between the second account and a second counterparty whereby market risk is transferred to the second account from the second counterparty; and

calculating one of gains and losses in said second account at a future date from the investment date.

### BRIEF DESCRIPTION OF THE DRAWINGS

FIG. 1 is a block diagram depicting a tier one transaction;

FIG. 2 is a block diagram depicting a tier two transaction;

FIG. 3 is a block diagram depicting an alternate form of a tier two transaction.

FIG. 4 is a block diagram depicting a computer system to manage a sale of a split fund unit;

FIG. 5 is a block diagram depicting a computer system to manage a redemption of a split fund unit;

FIG. 6 is a block diagram depicting a computer system to manage a redemption of a split fund contract;

FIG. 7 is a block diagram depicting a computer system to manage a declaration of a dividend by a split fund; and

FIG. 8 is a block diagram depicting a computer system to manage the pricing of split fund units and split fund contracts.

### DEFINITIONS

Account

A formal banking, brokerage, or business relationship established to provide for regular services, dealings, and other financial transactions.

Call Option

A contract that gives the holder the right to buy the underlying asset by a certain date for a certain price.

Cash-settled

A derivative contract that is settled on a cash basis based on the price of the underlying, in contrast to those that specify the delivery of a commodity or financial instrument. A derivative contract without an easily exchangeable underlying asset (a broad index of securities) is usually cash-settled.

Counterparty

An entity (individual or organization) with whom one transacts business. A counterparty can be a bank, mutual fund, financial services company, trust, limited partnership or other organization authorized to issue securities and enter into derivative contract agreements.

Credit Risk

Credit risk occurs when a counterparty is unable to fulfill its contractual obligation. This usually involves either a default on the principal or the suspension of payments of the interest, either way it is an interruption of the expected cash flows.

Derivative Instrument

A financial instrument or other contract with all three of the following characteristics:

a. It has firstly one or more underlyings and secondly one or more notional amounts or payment provisions or both. Those terms determine the amount of the settlement or settlements, and, in some cases, whether or not a settlement is required.

b. It requires no initial net investment or an initial net investment that is smaller than would be required for other types of contracts that would be expected to have a similar response to changes in market factors.

c. Its terms require or permit net settlement, it can readily be settled net by a means outside the contract, or it provides for delivery of an asset that puts the recipient in a position not substantially different from net settlement.

Fair Market Value

The amount of the consideration that would be agreed upon in an arm's length transaction between knowledgeable, willing parties who are under no compulsion to act.

Forward Contract

An agreement between two parties, to buy or sell an asset at a certain future time at a fixed price.

Fund Manager

An entity (individual or organization) that, in addition to being a counterparty, is charged with investing money on behalf of investors. In this case, the fund manager can be a bank, mutual fund, financial services company, trust, limited partnership or other organization authorized to issue securities, enter into derivative contract agreements and manage funds on behalf of other (third party) investors.

Investor

An economic entity that commits money in order to earn a financial return.

Mark-to-market

To record the price or value of a security, portfolio, or account to reflect its current market value.

Market Risk

Market risk results from a change in the prices of assets and liabilities, and are measured by the changes (or volatilities) in the value or earnings of a portfolio.

Notional Amount

A number of currency units, shares, bushels, pounds, or other units specified in a derivative instrument.

Pension Trust

A pension plan in which the plan sponsor chooses a trustee to be responsible for investing the plan's assets or for choosing an investor for the plan's assets.

Put Option

A contract that gives the holder the right to sell the underlying asset by a certain date for a certain price.

Sponsor Corporation

A corporation which has adopted and maintains a pension or employee-benefit plan.

Strike Price

The stated price for which an underlying asset may be purchased (for a call) or sold (for a put) by the option holder upon exercise of the option contract.

Tracking Error

An unplanned divergence between the price behavior of an underlying position or portfolio and the price behavior of a hedging position or benchmark. Tracking error can create a windfall profit or loss.

Underlying

A specified interest rate, security price, commodity price, foreign exchange rate, index of prices or rates, or other variable. An underlying may be a price or rate of an asset or liability but is not the asset or liability itself.

Underlying Asset

The asset, such as shares or commodities on which a derivative contract is based. It is the security or property that parties agree to exchange in a derivative contract that is not cash-settled.

### DETAILED DESCRIPTION

A preferred embodiment of the present invention relates to two regulatory environments of a single economic entity. A first account lies in one regulatory environment and a second account in a different regulatory environment. The preferred embodiment of the present invention includes the following limitations:

I. ownership of the investment portfolio resides in the first account;

II. some market risk is transferred from the first account to the second account;

III. there is no transfer of credit risk from the second account to the first account; and

IV. there is the potential for recognizing gains and losses in the future. Preferably, that future date may be greater than one year.

There are a number of different embodiments of the present invention that can achieve this result. These embodiments represent a general class of processes. The general class contains a number of processes with slight variations, each of which can be further divided into processes with other minor variations. The entire class of transactions is designated as ALIgn™ (Asset Liability Integration) Processes, and the individual processes as tier one, tier two, tier three, etc.

General ALIgn™ Process

The general ALIgn™ process is a process that includes the four elements listed above. The transactions are divided into different “tiers”, depending upon the location of the portfolio being managed.

Tier One Transaction

An investor has two accounts. Each account is in a separate regulatory environment, and there is some form of restriction or penalty for transferring assets from one environment to the other. A first account is in an environment with the most inter-environment transfer restrictions or penalties.

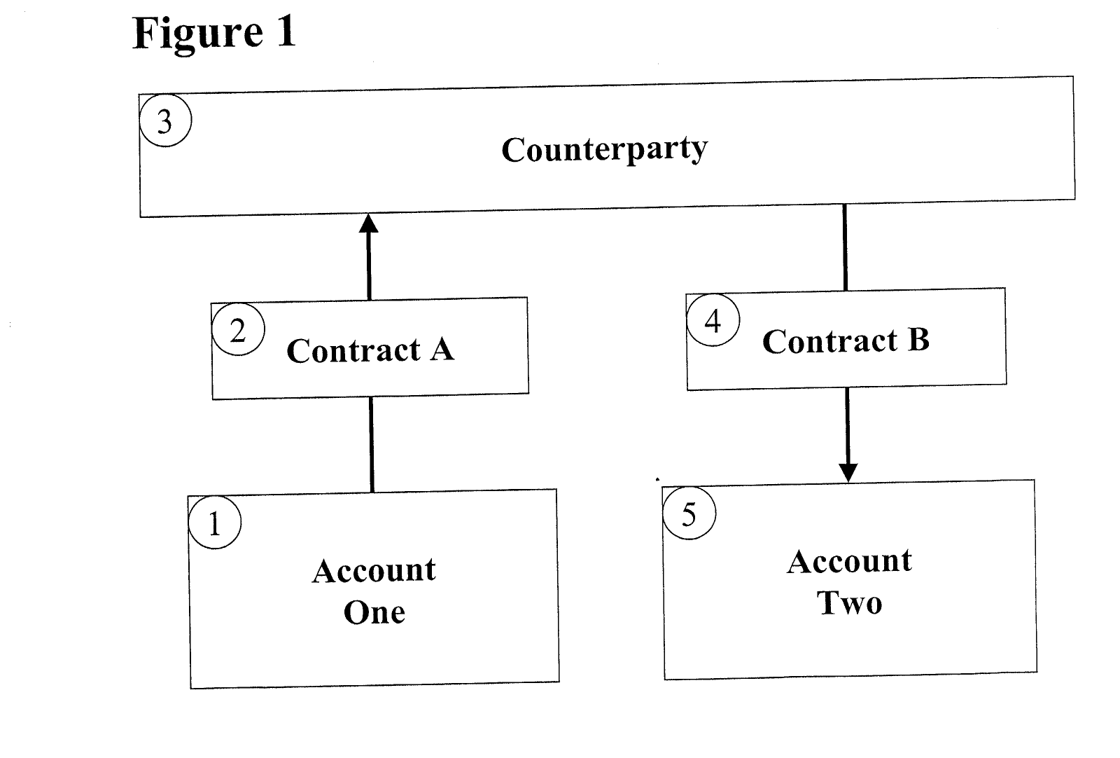

A tier one transaction is depicted in FIG. 1. The first account (1) holds direct ownership of an investment portfolio. The first account now transacts with a counterparty (3). The transaction takes the form of a financial contract (“contract A”) (2), or a combination of contracts, such as forward or option contracts, or other derivative instruments that transfer market risk to the counterparty. The result is that the market risk of the portfolio of the first account has been reduced. By reducing market risk, the first account has also given up possible returns. The counterparty pays the first account for this possible upside return or gain, through a premium (typically a sum of money) or a guarantee. The guarantee can be a promise to pay the first account a sum of money or securities in the event that a downside return or loss occurs. The contracts preferably have maturities in excess of one year, and can be as long as the two parties agree. For example, this time limit can be decades.

The second account (5) then enters into a reverse transaction with a counterparty (3). This transaction may be with the same counterparty as the first account or a different counterparty. If it is the same counterparty as transacted with the first account, the transaction must be done at fair market value and the transaction with the first account must not depend directly or indirectly on the transaction with the second account. The transaction takes the form of a financial contract (“contract B”) (4), or a combination of contracts, such as forward or option contracts, or other derivative instruments that transfer market risk from the counterparty to the second account. The result is that the second account has taken on market risk and thereby accepted the possibility of an upside return. The second account pays the counterparty for this possible upside return or gain, through a premium (typically a sum of money) or a guarantee. The guarantee can be a promise to pay the counterparty a sum of money or securities in the event that a downside return occurs. The contracts preferably have maturities in excess of one year, and can be as long as the two parties agree. This could be decades.

This process results in market risk being transferred from the first account to the second account, without transferring credit risk, while ownership of the investment portfolio still resides in the first account.

Tier Two Transaction

The investor again has first and second accounts. Each account is in a separate regulatory environment, and there is some form of restriction or penalty for transferring assets from one environment to the other. The first account is again in the environment with the most inter-environment transfer restrictions.

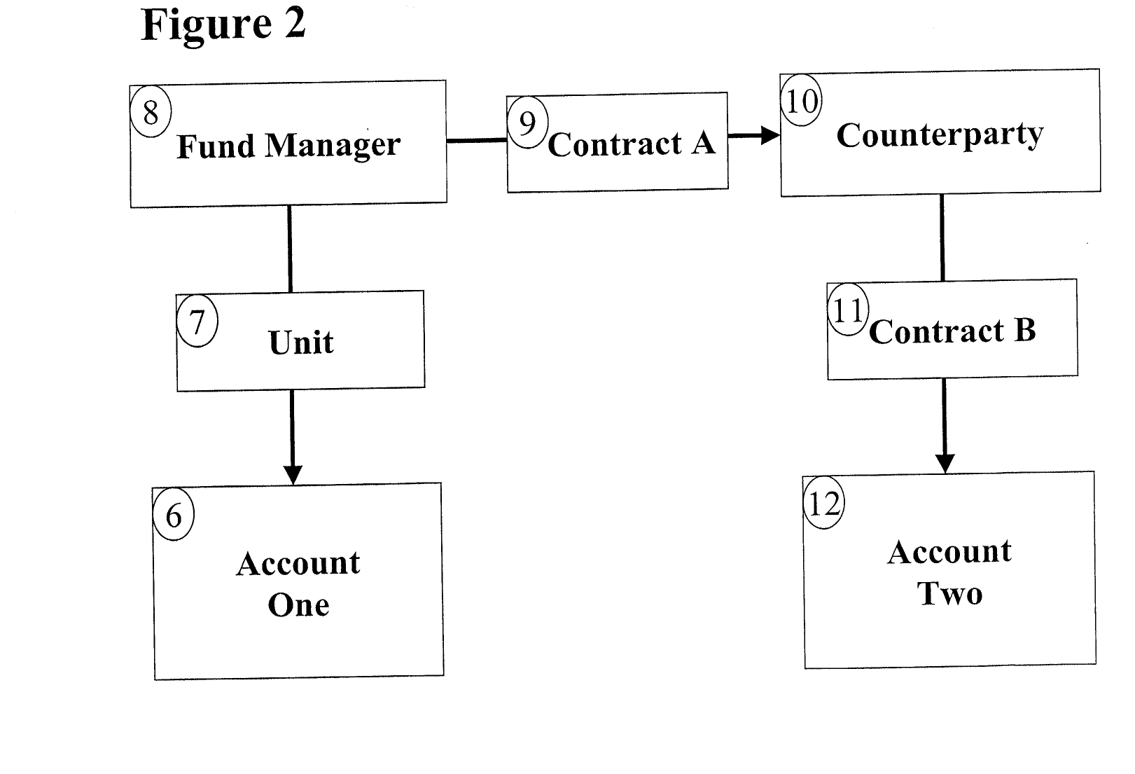

A tier two transaction is depicted in FIG. 2. A third party fund manager (8) holds the portfolio being managed. The first account (6) holds partial or complete ownership of that portfolio through units or shares (7) that the fund manager has sold to the first account. The fund manager now transacts with a counterparty (10). The transaction takes the form of a financial contract (contract A) (9), or combination of contracts, such as forward or option contracts, or other derivative instruments that transfer market risk to the counterparty. The result is that the market risk of the fund manager's portfolio has been reduced, and thereby, the risk of the investment of the first account in the portfolio has been reduced. By reducing market risk, the fund manager has also given up possible returns. The counterparty pays the fund manager for this possible “upside” return, through a guarantee or a premium (typically a sum of money). The guarantee can be a promise to pay the fund manager a sum of money or securities in the event that a downside return or loss occurs. The contracts preferably have maturities in excess of one year, and can be as long as the two parties agree. This could be decades.

A second account (12) enters into a reverse transaction with a counterparty. This transaction may be with the same counterparty as dealt with the fund manager or a different counterparty. If it is the same counterparty as transacted with the fund manager, the transaction must be done at fair market value. The transaction takes the form of a financial contract (“contract B”), or combination of contracts, such as forward or option contracts, or other derivative instruments that transfer market risk from the counterparty, to the second account. The result is that the second account has taken on market risk and thereby accepted the possibility of a gain. The second account pays the counterparty for this possible gain, through a guarantee or a premium (typically a sum of money). The guarantee can be a promise to pay the counterparty a sum of money or securities in the event that a loss occurs. The contracts preferably have maturities in excess of one year, and can be as long as the two parties agree. This can be decades.

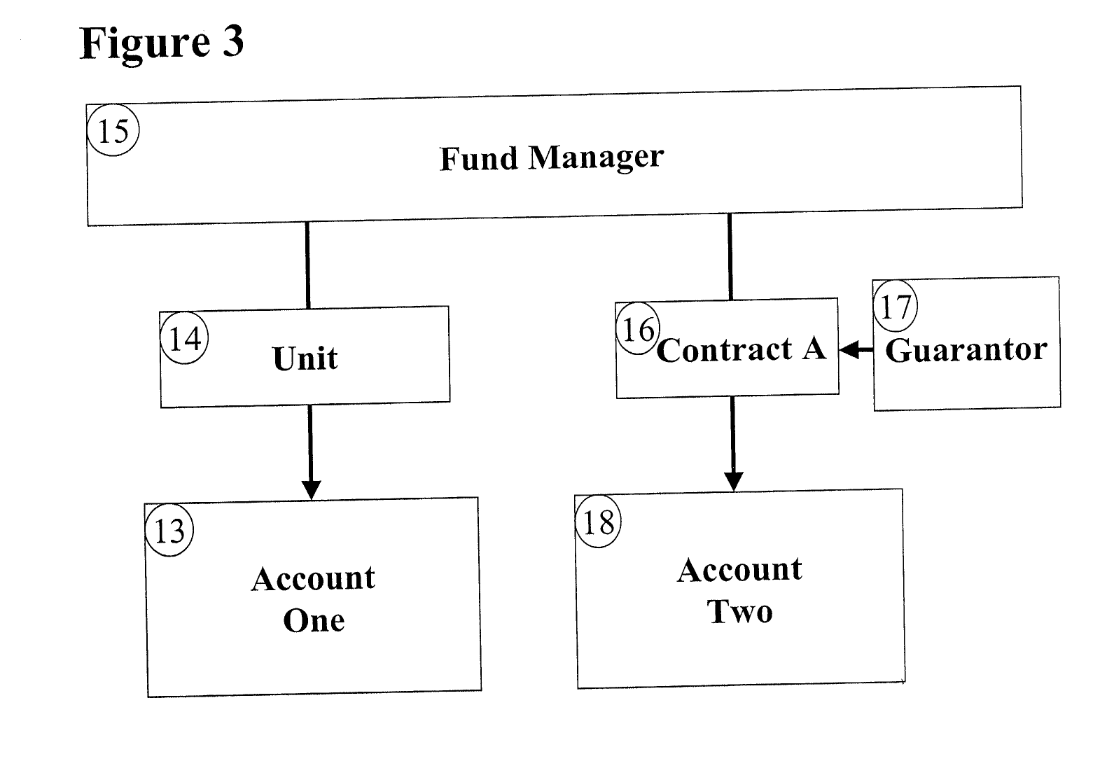

Tier two transactions can have a number of minor variations to them as shown in FIG. 3. A third party fund manager (15) holds the portfolio being managed. A first account (13) holds partial or complete ownership of that portfolio through units or shares (14) that the fund manager has sold to the first account. The fund manager is a separate third party organization. The fund manager now transacts with a second account (18). The transaction takes the form of a financial contract (contract A) (16), or combination of contracts, such as forward or option contracts, or other derivative instruments that transfer market risk to the second account. The result is that the market risk of the fund manager's portfolio has been reduced, and thereby, the risk of the investment of the first account in the portfolio has been reduced. By reducing market risk, the fund manager has also given up possible returns. The transaction should be done at fair market value, and the terms of the ownership of the unit in the first account should not depend directly or indirectly on the transaction involving the second account. The result is that the second account has taken on market risk and thereby accepted the possibility of a gain. The second account pays the fund manager for this possible gain, through a premium or a guarantee. The premium is typically a sum of money. The guarantee can be a promise to pay the fund manager a sum of money or securities in the event that a loss occurs. The contract cannot expose the fund manager to any credit risk on the part of the second account. Therefore in the event that payment is in the form of a guarantee, a third party guarantor (17), such as a bank, would be required. The contracts preferably have maturities in excess of one year, and can be as long as the two parties agree. This can be decades.

Tier Two Plus Transaction

A tier two plus (i.e. a tier three, tier four, etc.) transaction is a transaction in which the management of the portfolio and the ownership is further removed. In a tier three transaction, the fund manager of the portfolio has sold shares or units in the ownership of the portfolio to another fund manager which in turn sold shares or units in the ownership of the entity to the first account. A tier four transaction has an additional intermediary over the tier three transaction. A tier five transaction has an additional intermediary over the tier four transaction.

### EXAMPLES

FIG. 1 sets out an example of a tier one transaction. There are three variations described below. These are a) an option collar transaction, b) a forward contract transaction and c) a hybrid call option transaction. These transactions all have the same fundamental characteristics.

A first account (1) begins with an original investment portfolio. An index or combination of indices is selected as a proxy for that portfolio, thereby forming a proxy portfolio. For example, if the original portfolio consisted of a portfolio with 20% Canadian equities and 80% American equities, then the proxy portfolio might consist of a combination of 20% TSE 300 index (a broad based Canadian equity index) and 80% S&P 500 index (a broad based American equity index). There is a tracking error between the original portfolio and the proxy portfolio if the proxy portfolio is not identical. It may not be necessary to use broad based indices as proxy portfolios. It may be possible to create multiple narrow based proxy portfolios to reduce tracking error, or to have the proxy portfolio identical to the original portfolio.

It is important to note that in all tier one transactions, contract A (2) held by the first account (1) does not refer to or depend upon the performance of contract B (4) held by the second account (5). Contract A held by the first account does not contain provisions that are dependent on or affected by provisions in, or events relating to, contract B held by the second account. For instance, there is no clause to the effect that in the event that the contract of the second account is terminated, or is in default, that this affects the contract held by the first account.

### Example 1

Option Collar Transaction

A call option gives the holder or buyer the right, but not the obligation, to buy the underlying asset by a certain date for a certain price. A writer or seller of a call option is obligated to sell the underlying asset in the event that the holder exercises their option right. In return for this right, the buyer pays the writer a premium. This is usually a sum of money. A put option is the reverse of a call option, in that it gives the holder the right, but not the obligation, to sell the underlying asset by a certain date for a certain price. The writer of a call option is obligated to buy the underlying asset in the event that the holder exercises their option.

The price in an option contract is known as the exercise price or strike price. The date in the contract is known as the expiration date, exercise date, strike date or maturity date. American options can be exercised at any time up to the expiration date. European options can only be exercised on the expiration date itself.

An option collar is created where one party writes a call option and buys a put option, such that the call option strike price is greater than the put option strike price. The result is a band or collar, consisting of the difference between the call option strike price and the put option strike price. The top of the band is the ceiling. This is the call option strike price, while the bottom is the floor. This is the put option strike price. The collar allows for a guaranteed rate of return (i.e., the floor), measured against an underlying asset or index that fluctuates in value. This can be a proxy that derives its value from an asset or index. This guarantee is paid for by limiting the upside potential return (i.e., the ceiling). In the option collar transaction, the top and bottom of the collar can be expressed as percentages representing the moving average of the long term return in relation to an initial value of zero. For example, 9% for the top and 5% for the bottom. The buyer of a collar has their downside limited by the floor and their upside limited by the ceiling. The writer of a collar takes on the downside risk which is the possibility that the underlying price will fall below the floor. The writer is compensated by having the right to participate in any upside return which is the possibility that the underlying price will exceed the ceiling.

The transaction then works in the following way. A first account enters into contractual relations with a counterparty (contract A) (2). Within contract A, the first account writes a call option and buys a put option, thereby creating an option collar, with an initial value of zero. This is linked to the rate of the combined index return on the proxy portfolio. The first account is therefore the collar buyer and the counterparty is the collar writer. The option collar, each of whose components can be cash-settled, now has the following effect. Where the combined index return on the proxy portfolio is above 9%, the first account pays the value of all returns above 9% to the counterparty. Where the combined index return on the proxy portfolio is below 5%, the first account is paid by the counterparty sufficient funds to match a 5% combined index return on the proxy portfolio. Where the combined index return on the proxy portfolio is between 5% and 9%, no funds change hands. These payments are settled at a specific future date identified in the contract and are collateralized on a mark-to-market basis. In effect, the option collar guarantees the first account a 5% return on the proxy portfolio, in exchange for, the first account agreeing to pay to the guarantor of that return the value of any return on the proxy portfolio that is greater than 9%. Contract A preferably has a maturity in excess of one year, and can be as long as the two parties agree. This can be decades.

A second account (5) also enters into a contractual relationship with a counterparty (contract B) (4). Contract B is the reverse of the transaction entered into by the first account. In this case, the second account is the writer of a collar, while the counterparty is the collar buyer. Again, the collar may consist of the difference between the ceiling represented by the call option strike price and the floor represented by the put option strike price, which may be based on the same thresholds (in this case, 9% and 5%, respectively). The proxy portfolio selected by the second account may be composed of the same combination of indices as the proxy portfolio used by the first account. It is important to note, though, that the second account does not enter into the reverse option collar with the first account.

The collar purchased by the second account may be the reverse of the collar purchased by the first account. This collar may similarly begin with an initial value of zero and may be linked to a parallel proxy portfolio. So, for example, if the combined index return on the proxy portfolio is above 9%, the second account receives the value of all returns above 9% from the counterparty. Where the combined index return on the proxy portfolio is below 5%, the second account pays the counterparty sufficient funds to match a 5% combined index return on the proxy portfolio. If the combined index return is between 5% and 9%, then no funds change hands. Once again, these payments are settled at a specific future date identified in the contract and are collateralized on a mark-to-market basis. In effect, the second account becomes, economically speaking, the guarantor of a 5% return on the proxy portfolio, and in exchange receives the value of any return on the proxy portfolio that is greater than 9%. Preferably, contract B has a maturity in excess of one year, and can be as long as the two parties agree. This can be decades.

### Example 2

Forward Contract Transaction

A forward contract is an agreement between two parties, to buy or sell an asset at a certain future time at a fixed price. The contract is usually between two financial institutions or between a financial institution and one of its corporate or institutional clients. It is not normally traded on an exchange.

One of the parties to a forward contract assumes a long position, thereby assuming the light and obligation to buy the underlying asset on a certain specified future date for a certain specified price. The other party assumes a short position, thereby assuming the right and obligation to sell the underlying asset on the same date for the same price. The specified price in a forward contract is referred to as the delivery price. At the time the contract is entered into, the delivery price is chosen so that the value of the forward contract to both parties is zero. Once it is entered into, it can have a positive or negative value, depending on the movements in the price of the asset. The forward contract is settled at maturity, typically on the delivery date.

The transaction works as follows with reference to FIG. 1. A first account (1), beginning with its original portfolio, enters into a forward contract (contract A) (2) with a counterparty, that is based on an index or combination of indices making up the proxy portfolio. Therefore, the proxy portfolio constitutes the forward contract's underlying asset. Having identified the value of the proxy portfolio at the time of the contract, the first account agrees to pay the counterparty the difference by which a rate of interest (such as the bank prime rate) falls below the combined index return on the proxy portfolio. The other party agrees to pay the first account the difference by which that rate of interest exceeds the combined index return on the proxy portfolio. So, for instance, if the interest rate specified in the forward contract is 7%, and the combined index return on the proxy portfolio is 10%, the first account pays the difference to the counterparty. However, if the combined index return on the proxy portfolio is 4%, the counterparty pays the first account the difference between that return and the contractually identified rate of interest of 7%. These payments are settled at a specific future date identified in the contract, and collateralized on a mark-to-market basis. Contract A preferably has a maturity in excess of one year, and can be as long as the two parties agree. This can be decades.

A second account (5) may also enter into a similar forward contract (contract B) (4) with a counterparty (3), where that counterparty is not necessarily the same counterparty that transacted with the first account. It is important to note, though, that the second account does not enter into or become party to the forward contract with the first account itself. The forward contract entered into by the second account may be based on the value of a proxy portfolio, which may consist of the same combination of indices as the proxy portfolio used in the forward contract entered into by the first account. Under the contract, the second account agrees to pay a counterparty the difference by which a rate of interest (such as the bank prime rate) exceeds the combined index return on the proxy portfolio. The counterparty agrees to pay the second account the difference by which that rate of interest falls below the combined index return on the proxy portfolio. So, for instance, if the interest rate specified in the forward contract is 7%, and the combined index return on the proxy portfolio is 10%, the counterparty pays the second account the difference between the 7% and the 10% return. However, if the combined index return on the proxy portfolio is 4%, the second account pays the counterparty the difference between that return and the contractually identified rate of interest of 7%. These payments are settled at a specific future date identified in the contract, and collateralized on a mark-to-market basis. Contract B has a maturity in excess of one year, and can be as long as the two parties agree. This can be decades.

### Example 3

Hybrid Call Option Transaction

There are numerous features that can be added to a basic option contract. Options with additional features are generically called exotic options. Hybrid call options are options that differ from a regular option contract in three ways. The first feature involves a changing exercise price. The exercise price can be expressed as percentages representing the moving average of the long term return in relation to an initial value of zero. For example, an annual rate of 8%. Therefore, the exercise price of the contract is each day greater than the previous day's exercise price. This rate of increase is based on some non negative rate of return, for example an annual rate of 8%. The second feature is that there is an initial period, whereby the option cannot be exercised without incurring significant penalties. The third feature has the characteristics of a forward contract where the value of the contract is used as collateral. This third feature is referred to as a hybrid forward.

At the end of the specified time period of the option component, two outcomes can occur. If the contract has a value at or near zero on the final strike date, then the contract expires. If the contract value exceeds a specified value on the final strike date, then it becomes a hybrid forward contract. This forward contract works in the following way. Like the call option, the contract has an exercise price and exercise date that changes over time. The buyer can exercise the contract at any time. However, in the event that the value of the contract falls below a specified level or levels, the buyer is forced to automatically exercise the contract.

There are a couple of benefits to this structure. The first is that the writer of the option hybrid contract does not take on any credit risk from the buyer. Therefore, anyone can purchase the contract, provided they pay the appropriate premium. The second benefit, is that it can exist indefinitely, provided the writer remains solvent, and provided that when the contract enters into its hybrid forward stage, its value does not fall below the specified level or levels.

The transaction then works as follows with reference to FIG. 1. A first account (1) writes a hybrid call option contract (contract A) (2) on an index or combination of indices making up the proxy portfolio. Therefore, a proxy portfolio constitutes the hybrid call option contract's underlying asset. A counterparty (3) buys the contract, paying the first account a premium. This is typically in the form of a sum of money.

A second account (5) also enters into a similar contract with a counterparty (3). The counterparty (3) does not necessarily have to be the same counterparty that transacted with the first account. In this case, the second account buys a hybrid call option contract, contract B (4) from a counterparty, paying that counterparty a premium which is typically but not necessarily a sum of money. It is important to note, though, that the second account does not enter into or become party to the option contract with the first account itself. The contract entered into by the second account may be based on the value of a proxy portfolio, which may consist of the same combination of indices as the proxy portfolio used in the contract entered into by the first account.

### Examples of a Tier Two Transaction

The following summary sets out an example of a tier two transaction. Three basic examples are described, although they all have the same fundamental characteristics. As in the tier one examples, the terminology of an option collar contract, a forward contract and a hybrid call option contract is used. A tier two transaction, where the fund manager deals directly with the second account, is described below.

An investor wishes to divide the performance of a portfolio into a low risk and high risk component and hold these components in separate accounts. The portfolio whose performance they wish to split is called the split fund. This split fund can be a mutual fund trust or corporation, stock or bond index, closed end fund or investment partnership that is permitted to issue shares or investment units. The mechanism through which they will split the performance is called the underlying fund. This underlying fund can be a mutual fund trust or corporation, closed end fund, investment partnership or any portfolio of securities whose value can be priced. Referring to FIG. 3, a fund manager's portfolio (15) is the split fund, and the fund manager may, but not necessarily, also manage both the split fund and the underlying fund.

The fund manager (15) begins with its original portfolio of investments. An index or combination of indices is selected as a proxy for that portfolio, thereby forming a proxy portfolio. This proxy portfolio is called the underlying fund. For example, if the fund manager's portfolio is made up of 20% Canadian equities and 80% American equities, then the proxy might consist of a combination of 20% TSE 300 index and 80% S&P 500 index. There is a tracking error between the fund manager's portfolio and the underlying fund when the underlying fund differs from the fund manager's portfolio. Broad based indices may not be necessary to act as proxy portfolios, and need not be merged. It is possible to create multiple narrow based proxy portfolios to reduce tracking error. It is also possible to use another fund managed by the fund manager as an underlying fund. For example, the fund manager may manage many different portfolios for clients. The investor may wish to split the performance of one of these portfolios. In this case, the fund manager's portfolio may also be the underlying fund. In this specialized case, the investor may perceive that the split fund is the mechanism through which the underlying fund's performance is split.

It is important to note, that in all three cases, the split fund unit held by the first account does not refer to or depend upon the credit performance of the split fund contract held by the second account. Nor is the purchaser of the split fund unit obligated in any way to enter into any other transaction with the split fund, including the purchase of the split fund contract. However, the split fund contract held by the second account may require the existence of the split fund unit held by the first account, and therefore may in fact refer to the split fund unit.

### Example 4

Two Tier Option Collar Transaction

This transaction works as follows with reference to FIG. 3. A first account (13) purchases from a fund manager (15) a split fund unit (14). This unit gives the holder the right to share in the split fund performance, as well as voting rights. It can be a mutual fund unit, or share or equity investment in a partnership. Having sold a split fund unit to the first account, the fund manager uses the proceeds of the sale to purchase units in the underlying fund or to purchase a portfolio that is similar or identical to that of the underlying fund.

The fund manager then sells to a second account (18) a split fund contract which is contract A (16). This contract is equivalent to having the fund manager buy an option collar, where the underlying is the underlying fund or a proxy portfolio whose behavior is similar to that of the underlying fund. An option collar is the same as was described in the tier one option collar transaction, and gives the holder the rights and obligations to share in the performance of the underlying fund. Since the split fund contract may require future performance on the part of the second account, a third party guarantor (17) is necessary to alleviate any credit risk.

### Example 5

Two Tier Forward Contract Transaction

A forward contract transaction is very similar to the option collar transaction. As in FIG. 3, a first account (13) purchases from a fund manager (15) a split fund unit (14). This unit gives the holder the right to share in the split fund performance, as well as voting rights. It can be a mutual fund unit, or share or equity investment in a partnership. Having sold a split fund unit to the first account, the fund manager uses the proceeds of the sale to purchase units in the underlying fund or to purchase a portfolio that is similar or identical to that of the underlying fund.

The fund manager then sells to a second account (18) a split fund contract which is contract A (16). This contract is a forward contract, where the underlying is the underlying fund or a proxy portfolio whose behavior is similar to that of the underlying fund. The fund manager now holds a short position in the forward contract and is the same as described in the tier one forward contract transaction. Since the split fund contract may require future performance on the part of the second account, a third party guarantor (17) is necessary to alleviate any credit risk.

### Example 6

Two Tier Hybrid Call Option Transaction

With reference to FIG. 3, a hybrid call option transaction works in the following way. A first account (13) purchases from a fund manager (15) a split fund unit (14). This unit gives the holder the right to share in the split fund performance, as well as voting rights. It is preferably a mutual fund unit, or share or equity investment in a partnership. Having sold a split fund unit to the first account, the fund manager uses the proceeds of the sale to purchase units in the underlying fund or to purchase a portfolio that is similar or identical to that of the underlying fund.

The fund manager then sells to a second account (18) a split fund contract (contract A) (16), and receives a premium from the sale. This is typically a sum of money. This contract is a hybrid call option contract, where the underlying is the underlying fund. A hybrid call option contract is the same as was described in the tier one hybrid call option contract transaction. The fund manager uses the premium to purchase additional units in the underlying fund or to purchase a portfolio that is similar or identical to that of the underlying fund. Since the split fund contract does not require future performance on the part of the second account, there is no need for a third party guarantor (17).

### Example 7

Tier One Forward Contract Transaction

In this example, with reference to FIG. 1, a second account (5) is a defined benefit pension and its corporate sponsor is a first account (1). The pension plan is worth $100,000,000 and the assets are invested in 50% U.S. equities and 50% U.S. bonds. The pension plan committee decides that it would prefer holding a lower risk portfolio, while still taking advantage of any gains due to active management of the portfolio. The sponsor corporation is content with the present risk structure. They decide to enter into a tier one forward contract transaction.

The pension plan writes a ten year $50,000,000 forward contract (contract A (2)) whose underlying is the S&P500 total return index with Bank A (3). Bank A writes the same contract with the same terms and conditions with Bank B (3). To complete the transaction, Bank B writes the same contract (4) with the same terms and conditions with the sponsor corporation.

The result is that the pension trust now holds a lower risk portfolio. The sponsor corporation will now take on additional risk directly. However, it was already taking on this risk indirectly through the pension agreement. Therefore, from the sponsor corporation's perspective the risk structure, barring bankruptcy, has barely changed.

### Example 8

Tier Two Hybrid Option Contract Transaction

With reference to FIG. 3, An investor wants to invest $1200 into fund A (120 units of Fund A at $10 per unit), but wants the investment to be split into a high risk and low risk component. In order to accomplish this, the investor engages in the following transaction.

The investor purchases 100 units (14) of split fund A (15) for $10 each and holds these units in the first account (13). The investor agrees to reinvest all fund distributions. Split fund A uses the $1000 from the sale of the split fund A units to purchase 100 units of fund A for $10 each. Next, the investor purchases from split fund A, 120 split fund A contracts (16) for $1.67 each for a total cost of $200 and holds these contracts in the second account (18). These contracts have the same characteristics as an option hybrid contract with an underling of fund A, therefore they do not require a guarantor (17). Split fund A uses the proceeds of the split fund A contract sale ($200) to purchase an additional 20 units of fund A for $10 each.

Split fund A now holds 120 units of Fund A worth $1200, and owes the investor the obligation on 120 split fund A contracts. The investor holds 100 units of split fund A units in the first account and 120 split fund A contracts in the second account.

The investor's position becomes:

First account=100 units of split fund A units (equivalent to 120 units of fund A less 120 split fund A contracts)

Second account=120 split fund A contracts

Total (Net) position=100 split fund A units+120 split fund A contracts=120 units of fund A−120 split fund A contracts+120 split fund A contracts=120 units of fund A

Computer System

Conventional computer processes can be used to implement the tier one transactions. These systems are available at most banks and financial institutions that must monitor their derivative positions.

The split fund is effectively writing covered calls, collars or hedging with forward contracts. In many cases, either legislation or its prospectus will not permit it to be in a naked written position where the value of the underlying in the split fund contracts exceed the value of the split fund portfolio. Therefore, it must have a system that monitors the values and holders of all split fund contracts, and their relationship with the split fund units.

Also, legislation may require the split fund contract holder to monitor certain attributes of the underlying fund. For example, some contracts may be considered constructive ownership transactions under various tax codes. These transactions will require the fund manager to monitor the net underlying long-term capital gain for each contract, and declare it to the investor.

In the case of a split fund with a large number of split fund unit and contract holders, it is necessary for a computer system to manage this data. The system must manage the sale of units and contracts by the fund, the redemption of units and contracts, dividend declarations, pricing, and all other necessary monitoring for regulatory and tax purposes.

The system of the present invention has means for processing data relating to a first derivative transaction between the first account and a first counterparty whereby market risk is transferred to the first counterparty and means for calculating one of gains and losses in said second account at a future date from the investment date. These means are preferably a computer, having a processor, memory, data storage device, data entry device and a data display device that can calculate either gains or losses in a second account at a future date from the investment date.

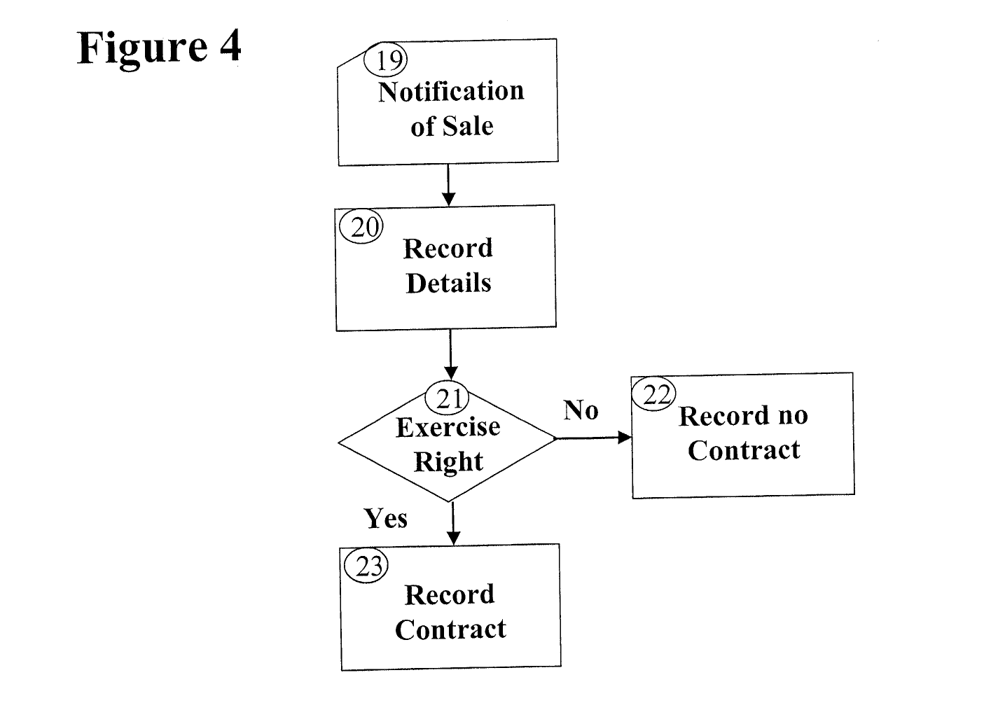

FIG. 4 describes a system for recording in a database, the sale of a split fund unit and contract to an investor. This database is either part of, or linked to, an existing standard database the fund company uses to monitor its units. The linkage is through the identification number or index number associated with the split fund unit. The fund manager receives notification that a split fund unit has been sold (19). Various details are recorded (20), such as the number of units, sale price, the name and address of the unit holder of record and all other relevant regulatory information. An index number is also assigned to each unit, where that number is unique for each unit. Each split fund unit sold will have its own unique unit identification number or index number. For each unit purchased, the holder is also permitted to purchase a split fund contract. The right to purchase that contract has no value, is transferable, is for administrative purposes only and must be exercised within a certain amount of time. For example, by the end of the month (21). In the event that the right is not exercised (22), there is no split fund contract purchased and it is recorded that there is no contract associated with the unit. In the event that a split fund contract is purchased (23), various details are recorded such as the number of contracts, sale price, the name and address of the contract holder of record, any other relevant regulatory information, the index number, contract start and strike dates, strike prices or a formula code and input variables if a formula is used, hybrid features, if any, the underlying used, the fact that there is a contract associated with the unit, and any other relevant information.

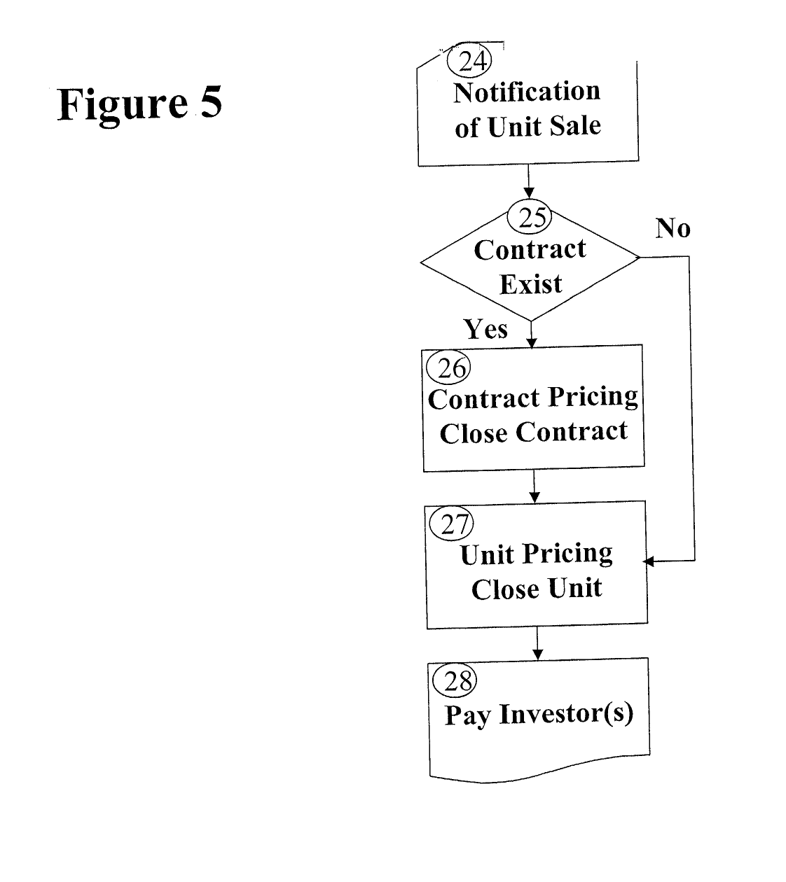

A computer system for recording the redemption of a split fund unit by an investor is described in FIG. 5. A fund manager is notified that the investor wishes to redeem a split fund unit (24). A database is queried as to whether a split fund contract is associated with a unit (25). If there is a contract associated with the unit, the contract is priced, sold and closed, with the database notified that the contract no longer exists (26). Once there is no longer a contract associated with the unit, the unit is sold (27). Proceeds of the contract sale are distributed to a registered contract owner and the proceeds of the unit sale are distributed to a unit owner (28).

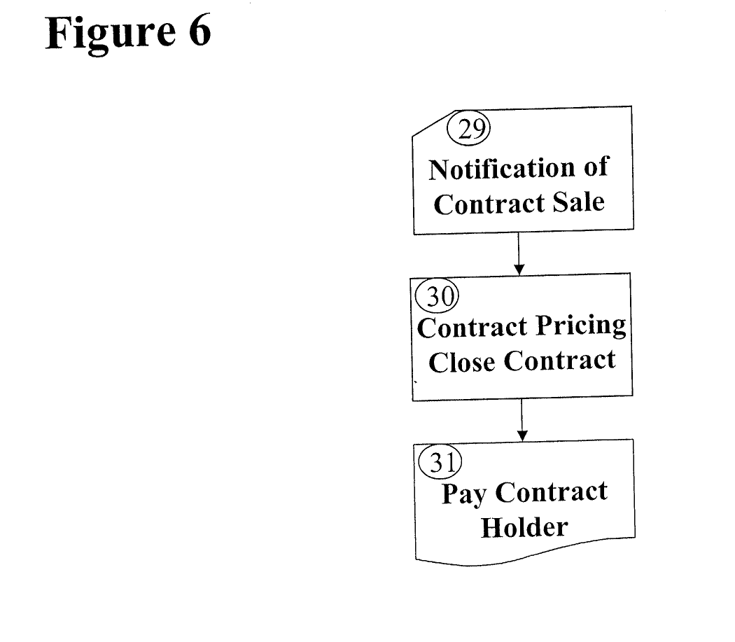

A computer system for recording the redemption of a split fund contract by an investor is described in FIG. 6. A fund manager is notified that an investor wishes to redeem a split fund contract (29). The contract is priced, sold and closed, with a database notified that the contract no longer exists (30). Proceeds of the contract sale are distributed to a registered contract owner (31).

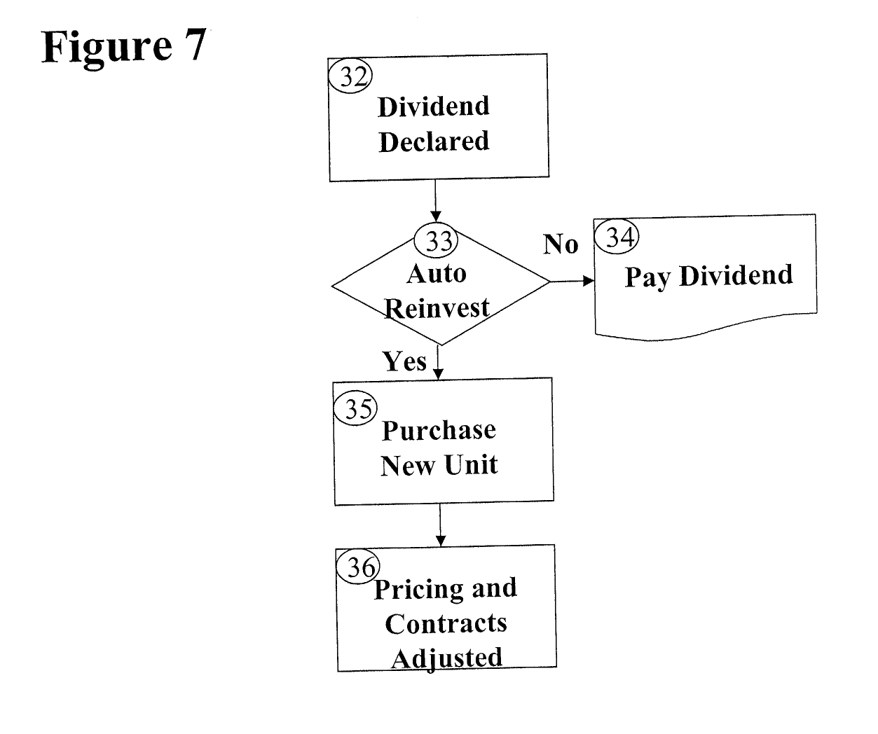

A computer system to manage dividend payments by the split fund to the unit holders is described in FIG. 7. A dividend is declared (32) and distributed to each split fund unit. In the event that there is no automatic reinvestment plan associated with that unit (33), then the dividend is paid to a unit holder of record (34). If there is an automatic reinvestment plan associated with that unit, then new units or partial units are purchased (35). When new units are purchased through automatic reinvestment plans, the units are priced and the contract pricing mechanisms are adjusted (36). The value of the contracts held by the contract holders is unchanged.

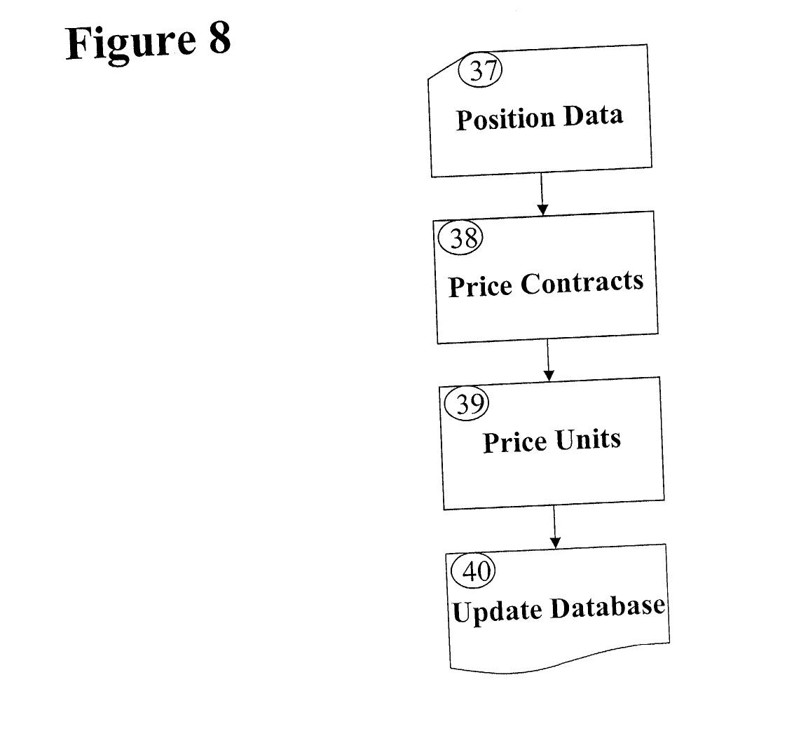

It is necessary to price split fund units and contracts, typically on a daily basis. FIG. 8 describes a computer system for pricing purposes. The value of a split fund portfolio and an underlying fund are recorded (37). The split fund contracts are priced, using an appropriate pricing formula (38). Depending upon the complexity of the split fund contract it can use a variety of pricing models including the Black-Scholes, Binomial, or Monte Carlo methods. The split fund contract always has some positive value until the final exercise (or maturity) price (or date). The split fund contracts are then priced based upon the value of the split fund portfolio, the value of the split fund contracts, and any fees that are to be deducted.

The split fund units can be priced once all split fund contracts are priced (39). Split fund units all have the same price, whereas many split fund contract prices will be different. Split fund units are priced by taking the total portfolio value, subtracting the value of all split fund contracts and then dividing the result by the number of split fund units outstanding. This will result in a split fund unit price. The database is updated with the new split fund unit and contract prices (40).

Although the invention has been described with preferred embodiments, it is to be understood that modifications may be resorted to as will be apparent to those skilled in the art. Such modifications and variations are to be considered within the purview and scope of the present invention.

1. A method of optimizing investment performance of an economic entity comprising the following steps:
providing on an investment date, a first account in a first regulatory environment, the first account owning an investment portfolio;
providing a second account in a second regulatory environment;
transferring market risk but not credit risk from the first account to the second account through a counterparty; and
recognizing one of gains and losses in said second account at a future date from the investment date.

2. A method according to claim 1 wherein the step of transferring market risk but not credit risk from the first account to the second account through a counterparty is accomplished according to the following sub-steps:
entering into a first derivative transaction between the first account and a first counterparty whereby market risk is transferred to the first counterparty; and
entering into a second derivative transaction between the second account and a second counterparty whereby market risk is transferred to the second account from the second counterparty.

3. A method according to claim 2 wherein the first counterparty and the second counterparty are separate counterparties.

4. A method according to claim 2 wherein the first counterparty and the second counterparty are the same counterparty.

5. A method according to claim 2 wherein the derivative transaction between the first account and the counterparty is carried out through an intermediary.

6. A method according to claim 5 wherein the intermediary is a counterparty selected from the group consisting of a fund manager, a bank, a mutual fund, a financial services company, a trust, a limited partnership, an organization that issues securities and enters into derivative contract agreements and an organization that manages funds on behalf of a third party.

7. A method according to claim 2 wherein a performance of the second derivative transaction is guaranteed by a third party guarantor.

8. A method according to claim 2 wherein the first derivative transaction is selected from the group consisting of a forward contract, an option contract, a collar contract and a derivative contract that transfers market risk.

9. A method according to claim 2 wherein the second derivative transaction is selected from the group consisting of a forward contract, an option contract, a collar contract and a derivative contract that transfers market risk.

10. A method according to claim 1 wherein the counterparty is selected from the group consisting of a bank, a mutual fund, a financial services company, a trust, a limited partnership, an organization that issues securities and enters into derivative contract agreements and an organization that manages funds on behalf of a third party.

11. A method according to claim 2 wherein the first account owns the investment portfolio indirectly through the ownership of an investment unit.

12. A method according to claim 1 wherein the future date from the investment date is at least one year.

13. A method according to claim 2 wherein said first and second derivative transactions are reverse transactions.

14. A system for optimizing investment performance of an economic entity comprising:
a first account in a first regulatory environment, said first account owning an investment portfolio on an investment date;
a second account in a second regulatory environment;
means for processing data relating to a transfer of market risk but not credit risk from the first account to the second account through a counterparty; and
means for calculating one of gains and losses in said second account at a future date from the investment date.

15. A system according to claim 14 further comprising:
means for processing data relating to a first derivative transaction between the first account and a first counterparty whereby market risk is transferred to the first counterparty; and
means for processing data relating to a second derivative transaction between the second account and a second counterparty whereby market risk is transferred to the second account from the second counterparty.

16. A system according to claim 15 wherein the first counterparty and the second counterparty are separate counterparties.

17. A system according to claim 15 wherein the first counterparty and the second counterparty are the same counterparty.

18. A system according to claim 15 wherein the derivative transaction between the first account and the counterparty is carried out through an intermediary.

19. A system according to claim 18 wherein the intermediary is a counterparty selected from the group consisting of a fund manager, a bank, a mutual fund, a financial services company, a trust, a limited partnership, an organization that issues securities and enters into derivative contract agreements and an organization that manages funds on behalf of a third party.

20. A system according to claim 15 wherein a performance of the second derivative transaction is guaranteed by a third party guarantor.

21. A system according to claim 15 wherein the first derivative transaction is selected from the group consisting of a forward contract, an option contract, a collar contract and a derivative contract that transfers market risk.

22. A system according to claim 15 wherein the second derivative transaction is selected from the group consisting of a forward, option, a collar contract and a derivative contract that transfers market risk.

23. A system according to claim 15 wherein the counterparty is selected from the group consisting of a bank, a mutual fund, a financial services company, a trust, a limited partnership, an organization that issues securities and enters into derivative contract agreements and an organization that manages funds on behalf of a third party.

24. A system according to claim 14 wherein the first account owns the investment portfolio indirectly through the ownership of an investment unit.

25. A system according to claim 14 wherein the future date from the investment date is at least one year.

26. A system according to claim 15 wherein said first and second derivative transactions are reverse transactions.

27. A system for transferring market risk but not credit risk of an economic entity from a first account owning an investment portfolio in a first regulatory environment to a second account in a second regulatory environment, the system comprising:
a memory for storing data relating to assets in said first and second accounts; and
a data processor for processing the data and calculating the value of said assets.

28. A system according to claim 27 wherein the market risk is transferred from the first account to the second account by way of a derivative transaction.

29. A system according to claim 28 wherein the derivative transaction is carried out through a counterparty.

30. A system according to claim 29 wherein the derivative transaction is carried out through an intermediary.

31. A system according to claim 29 wherein the intermediary is a counterparty selected from the group consisting of a fund manager, a bank, a mutual fund, a financial services company, a trust, a limited partnership, an organization that issues securities and enters into derivative contract agreements and an organization that manages funds on behalf of a third party.

32. A system according to claim 29 wherein a performance of the derivative transaction is guaranteed by a third party guarantor.

33. A system according to claim 28 wherein the derivative transaction is selected from the group consisting of a forward contract, an option contract, a collar contract and a derivative contract that transfers market risk.

34. A system according to claim 29 wherein the counterparty is selected from the group consisting of a bank, a mutual fund, a financial services company, a trust, a limited partnership, an organization that issues securities and enters into derivative contract agreements and an organization that manages funds on behalf of a third party.

35. A system according to claim 27 wherein the first account owns the investment portfolio indirectly through the ownership of an investment unit.

36. A data processing system for managing the investment performance of an economic entity having a first account in a first regulatory environment and a second account in a second regulatory environment, said first account having an investment portfolio on an investment date, the system comprising:
a data processor for processing data relating to a transfer of market risk but not credit risk from the first account to the second account through a counterparty; and
a computer for storing data relating to assets in the first and second accounts and calculating one of gains and losses in the value of assets in said second account at a future date from the investment date.

37. A system according to claim 36 wherein the data processor processes data relating to a first derivative transaction between the first account and a first counterparty whereby market risk is transferred to the first counterparty and data relating to a second derivative transaction between the second account and a second counterparty whereby market risk is transferred to the second account from the second counterparty.

38. A system according to claim 37 wherein the derivative transaction between the first account and the counterparty is carried out through an intermediary.

39. A system according to claim 36 wherein the first account owns the investment portfolio indirectly through the ownership of an investment unit.

40. A computer readable storage medium containing computer executable code for instructing a computer to operate as follows:
storing data relating to a first account in a first regulatory environment, the first account owning an investment portfolio on an investment date;
storing data relating to a second account in a second regulatory environment;
processing data relating to a first derivative transaction between the first account and a first counterparty whereby market risk is transferred to the first counterparty;
processing data relating to a second derivative transaction between the second account and a second counterparty whereby market risk is transferred to the second account from the second counterparty; and
calculating one of gains and losses in said second account at a future date from the investment date.
